(19) United States
(12) Patent Application Publication
(10) Pub. No.: US 2021/0175512 A1
(43) Pub. Date: Jun. 10, 2021

(54) LITHIUM-ION RECHARGEABLE BATTERY

(71) Applicant: SHOWA DENKO K.K., Tokyo (JP)

(72) Inventors: Haruaki UCHIDA, Ichihara-shi, Chiba (JP); Akira SAKAWAKI, Ichihara-shi, Chiba (JP); Takaki YASUDA, Ichihara-shi, Chiba (JP)

(73) Assignee: SHOWA DENKO K.K., Tokyo (JP)

(21) Appl. No.: 16/771,719

(22) PCT Filed: Nov. 20, 2018
(86) PCT No.: PCT/JP2018/042840

§ 371 Date: Jun. 11, 2020

(30) Foreign Application Priority Data
Dec. 22, 2017 (JP) 2017-246640
Oct. 11, 2018 (JP) 2018-192560

(51) Int. Cl. H01M 4/66; H01M 4/80; H01M 10/0525

(52) U.S. Cl. CPC H01M 4/667; H01M 4/661; H01M 2004/027; H01M 10/0525; H01M 4/80

(57) ABSTRACT

A lithium-ion rechargeable battery (1) includes: a positive electrode layer (30) containing a positive electrode active material; a solid electrolyte layer (40) containing an inorganic solid electrolyte; a storage layer (50) made of porous platinum (Pt) and storing lithium; a coating layer (60) made of an amorphous metal or alloy; and a negative electrode collector layer (70) made of platinum (Pt); these layers are stacked in this order.

### TECHNICAL FIELD

The present invention relates to a lithium-ion rechargeable battery.

### BACKGROUND ART

With widespread use of portable electronics, such as mobile phones and laptop computers, a strong need exists for small and lightweight rechargeable batteries with a high energy density. Known examples of the rechargeable batteries meeting such a need include lithium-ion rechargeable batteries. The lithium-ion rechargeable battery includes a positive electrode containing a positive electrode active material, a negative electrode containing a negative electrode active material, and an electrolyte having lithium ion conductivity and disposed between the positive electrode and the negative electrode.

Conventional lithium-ion rechargeable batteries have used an organic electrolyte solution and the like as an electrolyte. Meanwhile, use has been proposed of a solid electrolyte made of an inorganic material (inorganic solid electrolyte) as an electrolyte, and it has also been proposed to dispose a block region containing a positive electrode active material in a negative electrode collector on the negative electrode side; the block region helps prevent lithium from diffusing in the negative electrode collector (see Patent Document 1).

### CITATION LIST

### Patent Literature

Patent Document 1: Japanese Patent Application Laid-Open Publication No. 2013-164971

### SUMMARY OF INVENTION

### Technical Problem

However, even when a block region containing a positive electrode active material is disposed in a negative electrode collector, there have been cases where lithium passes through the block region to leak outside of the lithium-ion rechargeable battery.

An object of the present invention is to prevent lithium from leaking outside of an all-solid lithium-ion rechargeable battery.

### Solution to Problem

According to a first aspect of the present invention, there is provided a lithium-ion rechargeable battery including, in the following order: a solid electrolyte layer containing an inorganic solid electrolyte having lithium ion conductivity; a storage layer configured to store lithium; and an amorphous metal layer made of a metal or an alloy and having an amorphous structure.

In the above lithium-ion rechargeable battery, the amorphous metal layer may contain chromium (Cr).

The amorphous metal layer may be made of an alloy of chromium (Cr) and titanium (Ti).

The amorphous metal layer may be made of a metal or an alloy that does not form an intermetallic compound with lithium.

The amorphous metal layer may be made of any one of ZrCuAlNiPdP, CuZr, FeZr, TiZr, CoZrNb, NiNb, NiTiNb, NiP, CuP, NiPCu, NiTi, CrTi, AlTi, FeSiB, and AuSi.

The storage layer may be made of a platinum group element (Ru, Rh, Pd, Os, Ir, or Pt) having a porous structure, gold (Au) having a porous structure, or an alloy of some of the platinum group elements or at least one of the platinum group elements and the gold having a porous structure.

The storage layer may be made of titanium having a plurality of columnar crystals each extending in a thickness direction.

The storage layer may contain a negative electrode active material.

The storage layer may contain a positive electrode active material.

The above lithium-ion rechargeable battery may further include a positive electrode layer on an opposite side of the solid electrolyte layer from the storage layer, the positive electrode layer containing a positive electrode active material. A plane size of the storage layer may be larger than a plane size of the positive electrode layer.

The above lithium-ion rechargeable battery may further include a noble metal layer on the amorphous metal layer, the noble metal layer being made of a platinum group element (Ru, Rh, Pd, Os, Ir, or Pt), gold (Au), or an alloy of some of the platinum group elements or at least one of the platinum group elements and the gold.

### Advantageous Effects of Invention

The present invention prevents or restrains lithium from leaking outside of an all-solid lithium-ion rechargeable battery.

### BRIEF DESCRIPTION OF DRAWINGS

FIG. 1 shows a sectional structure of a lithium-ion rechargeable battery of a first embodiment.

FIG. 2 is a flowchart of a method for manufacturing the lithium-ion rechargeable battery of the first embodiment.

FIG. 3 shows a sectional structure of the lithium-ion rechargeable battery of the first embodiment after film deposition and before an initial charge.

FIGS. 4A to 4C explain a procedure for producing a porous storage layer.

FIG. 5A is a cross-sectional STEM picture of the lithium-ion rechargeable battery after the film deposition and before the initial charge.

FIG. 5B is a cross-sectional STEM picture of the lithium-ion rechargeable battery after an initial discharge.

FIG. 6 shows a sectional structure of the lithium-ion rechargeable battery of a first modification of the first embodiment.

FIG. 7 shows a sectional structure of the lithium-ion rechargeable battery of a second modification of the first embodiment.

FIG. 8 shows a sectional structure of the lithium-ion rechargeable battery of a third modification of the first embodiment.

FIG. 9 shows a sectional structure of the lithium-ion rechargeable battery of a fourth modification of the first embodiment.

FIGS. 10A and 10B each show a sectional structure of the lithium-ion rechargeable battery of the second embodiment.

FIG. 11 shows a sectional structure of the lithium-ion rechargeable battery of the third embodiment.

FIG. 12 shows a cross-sectional STEM picture of the lithium-ion rechargeable battery of another exemplary configuration in the first embodiment.

### DESCRIPTION OF EMBODIMENTS

Embodiments of the present invention will be described in detail below with reference to the attached drawings. In the drawings as referred to in the below description, dimensions of each component, including size and thickness, may differ from actual ones.

### First Embodiment

### [Configuration of the Lithium-Ion Rechargeable Battery]

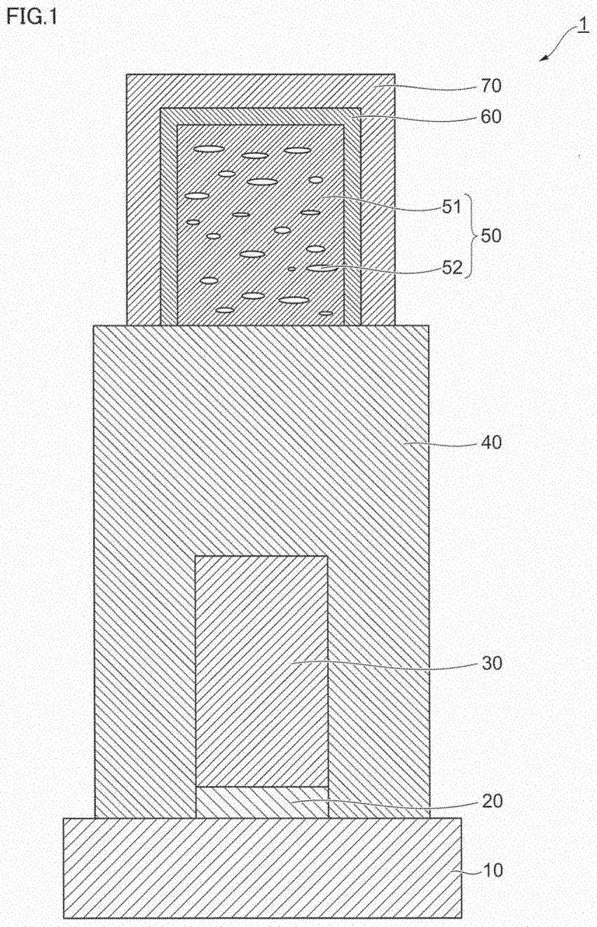

FIG. 1 shows a sectional structure of a lithium-ion rechargeable battery 1 of a first embodiment. As described later, the lithium-ion rechargeable battery 1 of the present embodiment has a multilayer structure composed of multiple layers (films); its basic structure is formed by a so-called deposition process, and the structure is completed by an initial charging and discharging operations. FIG. 1 shows the lithium-ion rechargeable battery 1 after the initial discharging operation, namely after completion of its structure.

The lithium-ion rechargeable battery 1 shown in FIG. 1 includes: a substrate 10; a positive electrode collector layer 20 stacked on the substrate 10; a positive electrode layer 30 stacked on the positive electrode collector layer 20; a solid electrolyte layer 40 stacked on the positive electrode layer 30; and a storage layer 50 stacked on the solid electrolyte layer 40. The solid electrolyte layer 40 covers peripheries of both of the positive electrode collector layer 20 and the positive electrode layer 30, and an end of the solid electrolyte layer 40 is directly stacked on the substrate 10, whereby the solid electrolyte layer 40 covers the positive electrode collector layer 20 and the positive electrode layer 30 jointly with the substrate 10. The lithium-ion rechargeable battery 1 further includes a coating layer 60 stacked on the storage layer 50 and also directly stacked on the solid electrolyte layer 40 around the periphery of the storage layer 50 to coat the storage layer 50 jointly with the solid electrolyte layer 40. The lithium-ion rechargeable battery 1 further includes a negative electrode collector layer 70 stacked on the coating layer 60 and also directly stacked on the solid electrolyte layer 40 around the periphery of the coating layer 60 to cover the coating layer 60 jointly with the solid electrolyte layer 40.

The above constituents of the lithium-ion rechargeable battery 1 will be described in more detail below.

### (Substrate)

The substrate 10 is not limited to a particular material, and may be made of any of various materials including metal, glass, and ceramics.

In the present embodiment, the substrate 10 is composed of a metal plate having electronic conductivity. More specifically, in the present embodiment, stainless steel foil (plate), which has higher mechanical strength than copper, aluminum and the like, is used as the substrate 10. Alternatively, metallic foil obtained by plating with conductive metals, such as tin, copper, chrome and the like, may be used as the substrate 10.

The substrate 10 may have a thickness of 20 μm or more and 2000 μm or less, for example. A thickness of less than 20 μm may lead to insufficient strength of the lithium-ion rechargeable battery 1. Meanwhile, a thickness of more than 2000 μm leads to reduced volume energy density and weight energy density due to increase in battery weight and thickness.

### (Positive Electrode Collector Layer)

The positive electrode collector layer 20 may be a solid thin film having electronic conductivity. As long as these conditions are met, the positive electrode collector layer 20 is not limited to a particular material and may be made of, for example, any conductive material including various metals and alloys of metals.

The positive electrode collector layer 20 may have a thickness of 5 nm or more and 50 μm or less, for example. With a thickness of less than 5 nm, the positive electrode collector layer 20 has reduced current collection capability, which makes the lithium-ion rechargeable battery 1 impracticable. Meanwhile, when the positive electrode collector layer 20 has a thickness of more than 50 μm, it increases internal resistance of the battery, which is disadvantageous for high speed charging/discharging.

While any known deposition method may be used to manufacture the positive electrode collector layer 20, such as various physical vapor deposition (PVD) and chemical vapor deposition (CVD) methods, it is preferable to use a sputtering method or a vacuum deposition method in terms of production efficiency.

When the substrate 10 is made of a conductive material such as a metal plate, there is no need to provide the positive electrode collector layer 20 between the substrate 10 and the positive electrode layer 30. When the substrate 10 is made of an insulating material, it is preferable to provide the positive electrode collector layer 20 between the substrate 10 and the positive electrode layer 30.

### (Positive Electrode Layer)

The positive electrode layer 30 is a solid thin film and contains a positive electrode active material that releases lithium ions during a charge and occludes lithium ions during a discharge. The positive electrode active material constituting the positive electrode layer 30 may be any of various materials such as oxides, sulfides or phosphorus oxides containing at least one kind of metals selected from manganese (Mn), cobalt (Co), nickel (Ni), iron (Fe), molybdenum (Mo), and vanadium (V). Alternatively, the positive electrode layer 30 may be made of a positive electrode mixture containing a solid electrolyte.

The positive electrode layer 30 may have a thickness of 10 nm or more and 40 μm or less, for example. With the positive electrode layer 30 having a thickness of less than 10 nm, the lithium-ion rechargeable battery 1 obtained therefrom has a too small capacity, which makes the lithium-ion rechargeable battery 1 impracticable. Meanwhile, with the positive electrode layer 30 having a thickness of more than 40 μm, it takes too much time to form the layer, which reduces productivity. The positive electrode layer 30 may, however, have a thickness of more than 40 μm when a large battery capacity is required of the lithium-ion rechargeable battery 1.

While any known deposition method may be used to fabricate the positive electrode layer 30, such as various PVD and CVD methods, it is preferable to use a sputtering method in terms of production efficiency.

### (Solid Electrolyte Layer)

The solid electrolyte layer 40 is a solid thin film and contains a solid electrolyte made of an inorganic material (inorganic solid electrolyte). The inorganic solid electrolyte constituting the solid electrolyte layer 40 is not limited to a particular material as long as the inorganic solid electrolyte has lithium ion conductivity, and may be made of any of various materials including oxides, nitrides, and sulfides.

The solid electrolyte layer 40 may have a thickness of 10 nm or more and 10 μm or less, for example. With the solid electrolyte layer 40 having a thickness of less than 10 nm, the lithium-ion rechargeable battery 1 obtained therefrom is prone to a short circuit (leakage) between the positive electrode layer 30 and the storage layer 50. Meanwhile, when the solid electrolyte layer 40 has a thickness of more than 10 μm, it increases internal resistance of the battery, which is disadvantageous for high speed charging/discharging.

While any known deposition method may be used to manufacture the solid electrolyte layer 40, such as various PVD and CVD methods, it is preferable to use a sputtering method in terms of production efficiency.

### (Storage Layer)

The storage layer 50 is a solid thin film and has a function to store lithium ions.

The storage layer 50 shown in FIG. 1 includes a porous part 51 with a number of pores 52. That is, the storage layer 50 of the present embodiment has a porous structure. This porous storage layer 50, or the porous part 51, is formed by initial charging and discharging operations after film deposition, which will be described in detail later.

The storage layer 50 (the porous part 51) may be made of a platinum group element (Ru, Rh, Pd, Os, Ir, Pt), gold (Au), or an alloy of some of these metals. Among these, the storage layer 50 is preferably composed of platinum (Pt) or gold (Au), which are less prone to oxidation. The storage layer 50 (the porous part 51) may be a polycrystal of any of the above noble metals or an alloy of some of these metals.

The storage layer 50 may have a thickness of 10 nm or more and 40 μm or less, for example. With a thickness of less than 10 nm, the storage layer 50 lacks sufficient capacity to store lithium. Meanwhile, when the storage layer 50 has a thickness of more than 40 μm, it increases internal resistance of the battery, which is disadvantageous for high speed charging/discharging. The storage layer 50 may, however, have a thickness of more than 40 μm when a large battery capacity is required of the lithium-ion rechargeable battery 1.

While any known deposition method may be used to manufacture the storage layer 50, such as various PVD and CVD methods, it is preferable to use a sputtering method in terms of production efficiency. Making the storage layer 50 porous is preferably done by charging and discharging, as described later.

### (Coating Layer)

The coating layer 60, which is an example of the amorphous metal layer, is a solid thin film made of any metal or alloy having an amorphous structure. Among these, in terms of corrosion resistance, the coating layer 60 is preferably made of a simple substance of chromium (Cr) or an alloy containing chromium, and more preferably made of an alloy of chromium and titanium (Ti). Also, the coating layer 60 is preferably made of any metal or alloy that does not form an intermetallic compound with lithium (Li). The coating layer 60 may also be composed of a stack of multiple amorphous layers made of different materials (e.g., a stack of an amorphous chromium layer and an amorphous chromium-titanium alloy layer). When the coating layer 60 is formed of an alloy, the range of composition ratio to produce an amorphous structure depends on layer forming conditions and thus a preferable range of composition ratio cannot be prescribed. The composition ratio may be selected depending on combination with layer forming conditions.

The term “amorphous structure” as referred to in the present embodiment not only means an entirely amorphous structure but also means an amorphous structure in which microcrystals are deposited.

The coating layer 60 may have a thickness of 10 nm or more and 40 μm or less, for example. With a thickness of less than 10 nm, the coating layer 60 may hardly block lithium having passed through the storage layer 50 from the solid electrolyte layer 40 side. Meanwhile, when the coating layer 60 has a thickness of more than 40 μm, it increases internal resistance of the battery, which is disadvantageous for high speed charging/discharging.

While any known deposition method may be used to manufacture the coating layer 60, such as various PVD and CVD methods, it is preferable to use a sputtering method in terms of production efficiency. In particular, when the coating layer 60 is made of the above chromium-titanium alloy, use of a sputtering method facilitates amorphization of the chromium-titanium alloy.

Examples of metals (alloys) that can be used for the coating layer 60 include ZrCuAlNiPdP, CuZr, FeZr, TiZr, CoZrNb, NiNb, NiTiNb, NiP, CuP, NiPCu, NiTi, CrTi, AlTi, FeSiB, and AuSi.

### (Negative Electrode Collector Layer)

The negative electrode collector layer 70, which is an example of the noble metal layer, may be a solid thin film having electronic conductivity. As long as these conditions are met, the negative electrode collector layer 70 is not limited to a particular material and may be made of, for example, any conductive material including various metals and alloys of metals. In terms of preventing corrosion of the coating layer 60, a chemically stable material is preferably used for the negative electrode collector layer 70; for example, the negative electrode collector layer 70 is preferably made of a platinum group element (Ru, Rh, Pd, Os, Ir, Pt), gold (Au), or an alloy of some of these metals.

The negative electrode collector layer 70 may have a thickness of 5 nm or more and 50 μm or less, for example. A thickness of less than 5 nm leads to reduced corrosion resistance and current collecting function of the negative electrode collector layer 70, which makes the lithium-ion rechargeable battery 1 impracticable. Meanwhile, when the negative electrode collector layer 70 has a thickness of more than 50 μm, it increases internal resistance of the battery, which is disadvantageous for high speed charging/discharging.

While any known deposition method may be used to manufacture the negative electrode collector layer 70, such as various PVD and CVD methods, it is preferable to use a sputtering method in terms of production efficiency.

### (Relationship Between the Positive Electrode Layer and the Storage Layer)

In the lithium-ion rechargeable battery 1, the positive electrode layer 30 and the storage layer 50 face each other across the solid electrolyte layer 40. That is, the positive electrode layer 30 containing a positive electrode active material is positioned on the opposite side of the solid electrolyte layer 40 from the storage layer 50. When viewed from above in FIG. 1, the plane size of the storage layer 50 is larger than that of the positive electrode layer 30. Also, when viewed from above in FIG. 1, the entire periphery of the plane of the positive electrode layer 30 is positioned within the entire periphery of the plane of the storage layer 50. Thus, a top face (plane) of the positive electrode layer 30 shown in FIG. 1 is faced with a bottom face (plane) of the storage layer 50 across the solid electrolyte layer 40.

### [Method for Manufacturing the Lithium-Ion Rechargeable Battery]

Below a description will be given of a method for manufacturing the above lithium-ion rechargeable battery 1.

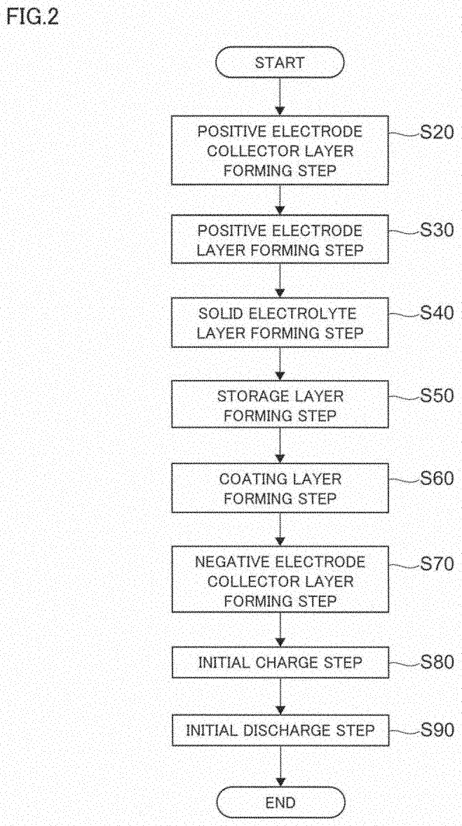

FIG. 2 is a flowchart of a method for manufacturing the lithium-ion rechargeable battery 1 of the first embodiment.

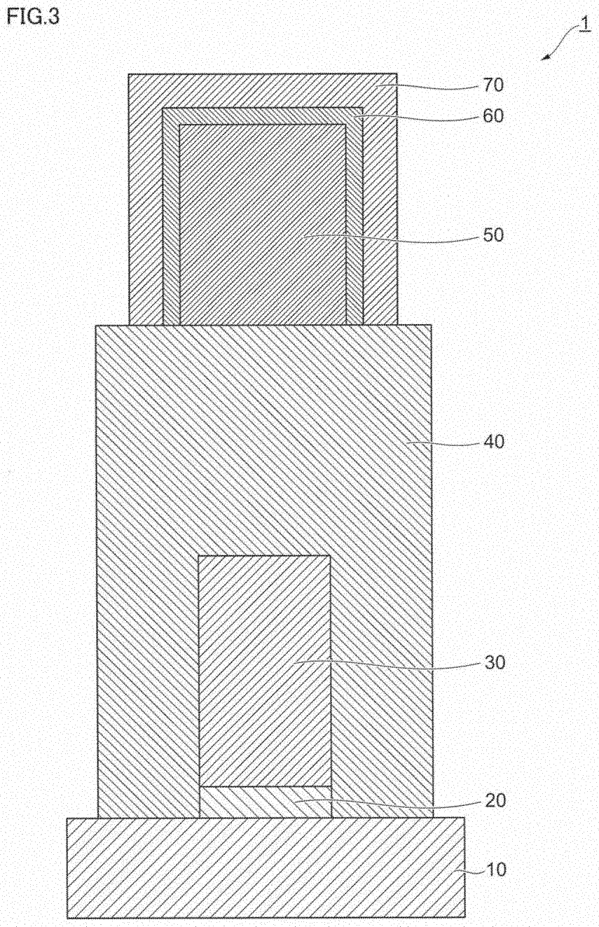

First, a positive electrode collector layer forming step is performed where the substrate 10 is mounted on a sputtering device (not shown) and the positive electrode collector layer 20 is formed on the substrate 10 (step 20). Then, a positive electrode layer forming step is performed where the positive electrode layer 30 is formed on the positive electrode collector layer 20 by the sputtering device (step 30). Then, a solid electrolyte layer forming step is performed where the solid electrolyte layer 40 is formed on the positive electrode layer 30 by the sputtering device (step 40). A storage layer forming step is then performed where the storage layer 50 is formed on the solid electrolyte layer 40 by the sputtering device (step 50). A coating layer forming step is performed where the coating layer 60 is formed on the solid electrolyte layer 40 and the storage layer 50 by the sputtering device (step 60). Then, a negative electrode collector layer forming step is performed where the negative electrode collector layer 70 is formed on the solid electrolyte layer 40 and the coating layer 60 (step 70). Executing these steps 20 to 70 results in the lithium-ion rechargeable battery 1 after film deposition (and before an initial charge) as shown in FIG. 3 described later. This lithium-ion rechargeable battery 1 is removed from the sputtering device.

Then, an initial charge step is performed where the lithium-ion rechargeable battery 1 removed from the sputtering device is given an initial charge (step 80). Subsequently, an initial discharge step is performed where the charge lithium-ion rechargeable battery 1 performs an initial discharge (step 90). Through these initial charge and discharge, the storage layer 50 becomes porous, or the porous part 51 and a number of pores 52 are formed, resulting in the lithium-ion rechargeable battery 1 shown in FIG. 1. The porous storage layer 50 produced by the initial charge and discharge will be detailed later.

[Configuration of the Lithium-Ion Rechargeable Battery after the Film Deposition and Before the Initial Charge]

FIG. 3 shows a sectional structure of the lithium-ion rechargeable battery 1 of the first embodiment after the film deposition and before the initial charge. FIG. 3 shows the lithium-ion rechargeable battery 1 when steps 20 to 70 shown in FIG. 2 have been completed. FIG. 1 shows the lithium-ion rechargeable battery 1 after completion of step 90 (i.e. all steps) shown in FIG. 2.

The basic structure of the lithium-ion rechargeable battery 1 shown in FIG. 3 is the same as that of the lithium-ion rechargeable battery 1 shown in FIG. 1, except that the storage layer 50 of the lithium-ion rechargeable battery 1 shown in FIG. 3 is not porous but denser than the storage layer 50 shown in FIG. 1. Additionally, the lithium-ion rechargeable battery 1 shown in FIG. 3 differs from the lithium-ion rechargeable battery 1 shown in FIG. 1 in that the thickness of the storage layer 50 shown in FIG. 3 is smaller than that of the storage layer 50 shown in FIG. 1.

### [Production of the Porous Storage Layer]

Below a detailed description will be given of production of the above porous storage layer 50.

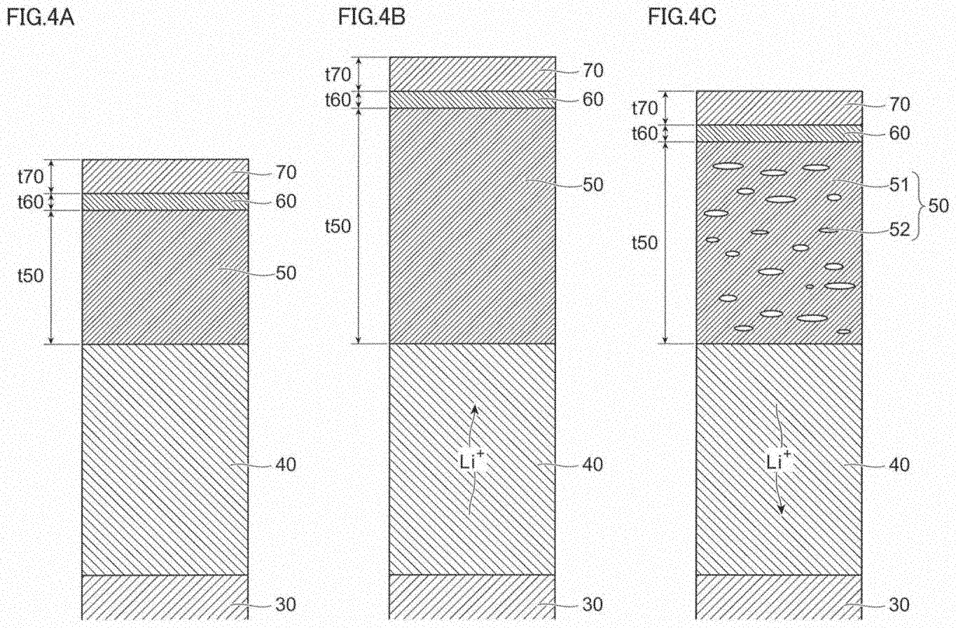

FIGS. 4A to 4C are enlarged views of the storage layer 50 and its nearby layers for explaining a procedure for producing the porous storage layer 50. FIG. 4A shows the state after the film deposition and before the initial charge (i.e. after step 70), FIG. 4B shows the state after the initial charge and before the initial discharge (i.e. the state between step 80 and step 90), and FIG. 4C shows the state after the initial discharge (i.e. after step 90). Thus, FIG. 4A corresponds to FIG. 3 and FIG. 4C corresponds to FIG. 1.

### (After the Film Deposition and Before the Initial Charge)

In the state after the film deposition and before the initial charge shown in FIG. 4A, the storage layer 50 is dense. The storage layer 50 has a storage layer thickness t50, the coating layer 60 has a coating layer thickness t60, and the negative electrode collector layer 70 has a negative electrode collector layer thickness t70.

### (After the Initial Charge and Before the Initial Discharge)

When the lithium-ion rechargeable battery 1 shown in FIG. 4A is charged (initially charged), a positive electrode of a DC power source is connected to the substrate 10 (see FIG. 1), and a negative electrode of the DC power source is connected to the negative electrode collector layer 70. This causes lithium ions (Lit) constituting the positive electrode active material in the positive electrode layer 30 to move through the solid electrolyte layer 40 to the storage layer 50. In other words, in the charging operation, lithium ions move in the thickness direction (in the upward direction in FIG. 4B) of the lithium-ion rechargeable battery 1.

At this time, the lithium ions having moved from the positive electrode layer 30 to the storage layer 50 are alloyed with the noble metal constituting the storage layer 50. For example, when the storage layer 50 is made of platinum (Pt), lithium is alloyed with platinum in the storage layer 50 (formation of a solid solution, formation of an intermetallic compound, or formation of a eutectic).

Also, some of lithium ions having entered the storage layer 50 pass therethrough to reach a boundary between the storage layer 50 and the coating layer 60. The coating layer 60 of the present embodiment is made of a metal or alloy having an amorphous structure and thus includes the significantly smaller number of grain boundaries than the storage layer 50, which has a polycrystalline structure. For this reason, the lithium ions having reached the boundary between the storage layer 50 and the coating layer 60 hardly enter the coating layer 60, and they remain stored within the storage layer 50.

After completion of the initial charge, the lithium ions having moved from the positive electrode layer 30 to the storage layer 50 are stored within the storage layer 50. The reason why the lithium ions having moved to the storage layer 50 are stored within the storage layer 50 is likely to be because the lithium ions are alloyed with platinum or metallic lithium is deposited in platinum.

As shown in FIG. 4B, after the initial charge and before the initial discharge of the lithium-ion rechargeable battery 1, the storage layer thickness t50 increases from its thickness after the film deposition and before the initial charge shown in FIG. 4A. In other words, the volume of the storage layer 50 is increased by the initial charge. This is likely to be because of alloying of lithium and platinum in the storage layer 50. On the other hand, the coating layer thickness t60 changes little before and after the initial charge. In other words, the volume of the coating layer 60 is changed little by the initial charge. This is likely to be because lithium hardly enters the coating layer 60. This assumption can be backed by the fact that the negative electrode collector layer thickness t70 changes little before and after the initial charge, or in other words, the volume of the negative electrode collector layer 70 changes little before and after the initial charge (platinum constituting the negative electrode collector layer 70 is not made porous, unlike platinum constituting the storage layer 50, and remains dense).

### (After the Initial Discharge)

When the lithium-ion rechargeable battery 1 shown in FIG. 4B is discharged (initially discharged), a positive side of a load is connected to the substrate 10 (see FIG. 1) and a negative side of the load is connected to the negative electrode collector layer 70. This causes lithium ions (Lit) stored in the storage layer 50 to move through the solid electrolyte layer 40 to the positive electrode layer 30, as shown in FIG. 4C. In other words, in the discharging operation, lithium ions move in the thickness direction (the downward direction in FIG. 4C) of the lithium-ion rechargeable battery 1 to be stored in the positive electrode layer 30. Along with this, a direct current is supplied to the load.

At this time, dealloying of the lithium-platinum alloy (when metal lithium is deposited in platinum, solubilization of metal lithium) takes place in the storage layer 50 as lithium leaves the storage layer 50. As a result of the dealloying in the storage layer 50, the storage layer 50 becomes porous, resulting in the porous part 51 with a number of pores 52. The thus-obtained porous part 51 is composed almost entirely of a noble metal (e.g., platinum). After completion of the initial discharge, however, lithium does not disappear in the storage layer 50 but some lithium that does not move during the discharging operation remains in the storage layer 50.

As shown in FIG. 4C, after the initial discharge of the lithium-ion rechargeable battery 1, the storage layer thickness t50 decreases from its thickness after the initial charge and before the initial discharge shown in FIG. 4B. This is likely to be because of the dealloying of the lithium-platinum alloy in the storage layer 50. This assumption can be backed by the fact that the shape of each pore 52 formed in the storage layer 50 by the initial discharge is flattened such that its length in the thickness direction is shorter than its length in the plane direction. Also, as shown in FIG. 4C, after the initial discharge of the lithium-ion rechargeable battery 1, the storage layer thickness t50 increases from its thickness after the film deposition and before the initial charge shown in FIG. 4A. This is likely to be because the storage layer 50 is made porous, or a large number of pores 52 are formed in the storage layer 50, by the initial charge and discharge. On the other hand, the coating layer thickness t60 and the negative electrode collector layer thickness t70 change little before and after the initial discharge.

### [Exemplary Configuration of the Lithium-Ion Rechargeable Battery]

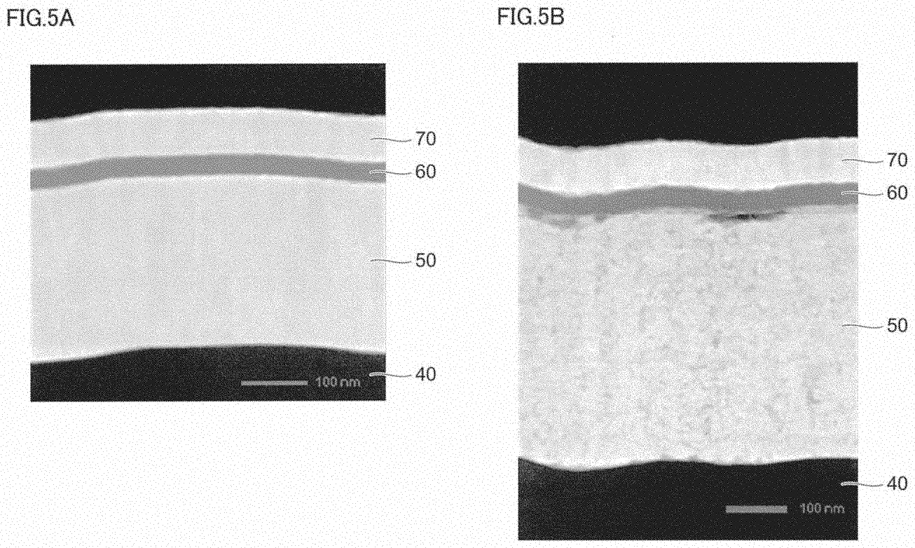

FIGS. 5A and 5B are cross-sectional scanning transmission electron microscope (STEM) pictures of the lithium-ion rechargeable battery 1 of the present embodiment; FIG. 5A shows a STEM picture of the lithium-ion rechargeable battery 1 after the film deposition and before the initial charge, and FIG. 5B shows a STEM picture of the lithium-ion rechargeable battery 1 after the initial discharge. These STEM pictures were taken by Ultra-thin Film Evaluation System HD-2300 from Hitachi High-Technologies Corporation. FIG. 5A corresponds to FIG. 4A (and FIG. 3), and FIG. 5B corresponds to FIG. 4C (and FIG. 1).

The specific configuration and manufacturing method of the lithium-ion rechargeable battery 1 shown in FIG. 5A are as follows.

Stainless steel (SUS304) was used as the substrate 10 (omitted in FIGS. 5A and 5B). The substrate 10 was 30 μm thick.

Aluminum formed by sputtering was used as the positive electrode collector layer 20 (omitted in FIGS. 5A and 5B). The positive electrode collector layer 20 was 100 nm thick.

Lithium manganate (Li_{1.5}Mn₂O₄) formed by sputtering was used as the positive electrode layer 30 (omitted in FIGS. 5A and 5B). The positive electrode layer 30 was 1000 nm thick.

LiPON (obtained by displacing a part of oxygen in lithium phosphate (Li₃PO₄) with nitrogen) formed by sputtering was used as the solid electrolyte layer 40. The solid electrolyte layer 40 was 1000 nm thick.

Platinum (Pt) formed by sputtering was used as the storage layer 50. The storage layer 50 was 410 nm thick (after the film deposition and before the initial charge).

Chromium-titanium alloy (more specifically, Cr₅₀Ti₅₀) formed by sputtering was used as the coating layer 60. The coating layer 60 was 50 nm thick.

Platinum (Pt) formed by sputtering was used as the negative electrode collector layer 70. The negative electrode collector layer 70 was 100 nm thick.

The thus-obtained lithium-ion rechargeable battery 1 after the film deposition and before the initial charge (see FIG. 3) was subjected to electron diffraction for analysis of its crystal structure. The results were as follows.

The substrate 10 made of SUS304, the positive electrode collector layer 20 made of aluminum, and the storage layer 50 and the negative electrode collector layer 70 made of platinum were crystalized. On the other hand, the positive electrode layer 30 made of lithium manganate, the solid electrolyte layer 40 made of LiPON, and the coating layer 60 made of chromium-titanium alloy were amorphous. However, rings were slightly observed in the electron diffraction patterns of the positive electrode layer 30, the solid electrolyte layer 40, and the coating layer 60; they were found to contain microcrystals in the amorphous structure.

The thus-obtained lithium-ion rechargeable battery 1 was subjected to the initial charge and the initial discharge.

### Initial Charge Conditions

Current: 1C

End voltage: 4.0V or 2 hours

### Initial Discharge Conditions

Current: 1C

End voltage: 2.0V

The STEM pictures shown in FIGS. 5A and 5B will be described below.

In FIG. 5A, the storage layer 50 is almost uniformly white, whereas in FIG. 5B, multiple gray spots are present on the white background. In FIG. 5B, some gray spots in the storage layer 50 near the boundary between the storage layer 50 and the coating layer 60 are flattened with a shorter length in the thickness direction than a length in the plane direction and are relatively larger than other gray spots in the storage layer 50. In FIG. 5B, the white background portion is considered as corresponding to the porous part 51, and the gray portions are considered as corresponding to the pores 52. In FIG. 5B, the storage layer 50 is thicker than the storage layer 50 shown in FIG. 5A. The storage layer 50 shown in FIG. 5B was 610 nm thick (after the initial discharge).

Both of the coating layer 60 and the negative electrode collector layer 70 have little change in gray level between the pictures of FIGS. 5A and 5B. Further, both of the coating layer 60 and the negative electrode collector layer 70 have little change in thickness between the pictures of FIGS. 5A and 5B.

### [Another Exemplary Configuration of the Lithium-Ion Rechargeable Battery]

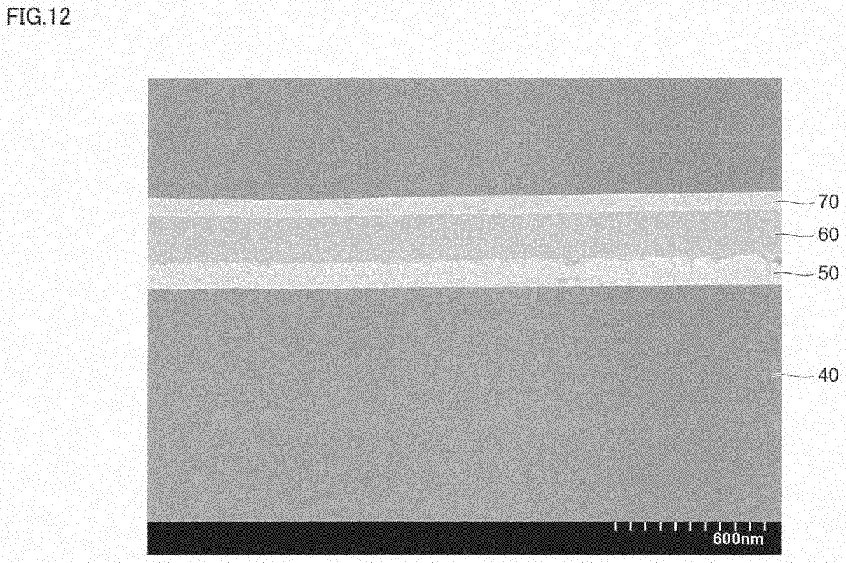

FIG. 12 shows a cross-sectional STEM picture of the lithium-ion rechargeable battery 1 of another exemplary configuration in the present embodiment. FIG. 12 shows the lithium-ion rechargeable battery 1 after the initial discharge. This picture was taken by Ultra-thin Film Evaluation System HD-2300 from Hitachi High-Technologies Corporation, similarly to the above pictures of FIGS. 5A and 5B. FIG. 12 corresponds to FIG. 4C (and FIG. 1) described above.

The specific configuration and manufacturing method of the lithium-ion rechargeable battery 1 shown in FIG. 12 are as follows.

Stainless steel (SUS304) was used as the substrate 10 (omitted in FIG. 12). The substrate 10 was 30 μm thick.

Aluminum formed by sputtering was used as the positive electrode collector layer 20 (omitted in FIG. 12). The positive electrode collector layer 20 was 100 nm thick.

Lithium manganate (Li_{1.5}Mn₂O₄) formed by sputtering was used as the positive electrode layer 30 (omitted in FIG. 12). The positive electrode layer 30 was 1000 nm thick.

Lithium phosphate (Li₃PO₄) formed by sputtering was used as the solid electrolyte layer 40. The solid electrolyte layer 40 was 1000 nm thick.

Platinum (Pt) formed by sputtering was used as the storage layer 50. The storage layer 50 was 70 nm thick (after the film deposition and before the initial charge).

CoZrNb alloy (more specifically, Co₉₁Zr₅Nb₄) formed by sputtering was used as the coating layer 60. The coating layer 60 was 200 nm thick.

Platinum (Pt) formed by sputtering was used as the negative electrode collector layer 70. The negative electrode collector layer 70 was 70 nm thick.

The thus-obtained lithium-ion rechargeable battery 1 after the film deposition and before the initial charge was subjected to electron diffraction for analysis of its crystal structure. The results were as follows.

The substrate 10 made of SUS304, the positive electrode collector layer 20 made of aluminum, and the storage layer 50 and the negative electrode collector layer 70 made of platinum were crystalized. On the other hand, the positive electrode layer 30 made of lithium manganate, the solid electrolyte layer 40 made of lithium phosphate (Li₃PO₄), and the coating layer 60 made of CoZrNb alloy were amorphous. However, rings were slightly observed in the electron diffraction patterns of the positive electrode layer 30, the solid electrolyte layer 40, and the coating layer 60; they were found to contain microcrystals in the amorphous structure.

The thus-obtained lithium-ion rechargeable battery 1 was subjected to the initial charge and the initial discharge. The initial charge and discharge conditions were the same as those explained using FIGS. 5A and 5B.

In FIG. 12, similarly to FIG. 5B above, some gray spots in the storage layer 50 near the boundary between the storage layer 50 and the coating layer 60 are flattened with a shorter length in the thickness direction than a length in the plane direction and are relatively larger than other gray spots in the storage layer 50. In FIG. 12, the white background portion is considered as corresponding to the porous part 51, and the gray portions are considered as corresponding to the pores 52, similarly to FIG. 5B. The storage layer 50 shown in FIG. 12 was 105 nm thick (after the initial discharge).

In this example too, both of the coating layer 60 and the negative electrode collector layer 70 had little change in gray level and thickness before and after the initial charge and discharge.

### Conclusion of the First Embodiment

As described above, in the lithium-ion rechargeable battery 1 of the present embodiment, the coating layer 60 made of a metal or an alloy having an amorphous structure is stacked on the storage layer 50 facing the positive electrode layer 30 across the solid electrolyte layer 40. This restrains lithium having moved from the positive electrode layer 30 to the storage layer 50 during the charging operation from leaking outside through the coating layer 60, as compared to, for example, when the coating layer 60 having a polycrystalline structure is stacked on the storage layer 50.

In the present embodiment, the porous storage layer 50 made of platinum is disposed on the solid electrolyte layer 40. This restrains peeling inside the lithium-ion rechargeable battery 1 caused by expansion due to charging or contraction due to discharging, as compared to, for example, when a negative electrode layer made of silicon (Si) is disposed on the solid electrolyte layer 40.

In the present embodiment, the negative electrode collector layer 70 made of platinum is disposed on the coating layer 60. This restrains corrosion (deterioration) of the metal or alloy constituting the coating layer 60 caused by oxidation and the like, as compared to, for example, when the negative electrode collector layer 70 made of a material other than noble metals is disposed on the coating layer 60.

In the lithium-ion rechargeable battery 1 of the present embodiment, the plane size of the storage layer 50 is larger than that of the positive electrode layer 30, which faces the storage layer 50 across the solid electrolyte layer 40. This restrains lithium ions from moving in a lateral direction (plane direction) when the lithium ions move from the positive electrode layer 30 to the storage layer 50. This, in turn, restrains outside leakage of lithium ions from sides of the lithium-ion rechargeable battery 1.

Though detailed description of this is not given here, when the storage layer 50 is made of any platinum group element (Ru, Rh, Pd, Os, Ir, Pt), gold (Au), or an alloy of some of these metals, the storage layer 50 can be made porous by charging and discharging and store lithium therein, similarly to the storage layer 50 solely composed of platinum (Pt).

### Modifications of the First Embodiment

In the lithium-ion rechargeable battery 1 of the first embodiment, the substrate 10 and the solid electrolyte layer 40 cover the positive electrode collector layer 20 and the positive electrode layer 30, and the solid electrolyte layer 40, the coating layer 60, and the negative electrode collector layer 70 cover the storage layer 50. The present invention is, however, not limited to this configuration.

### First Modification

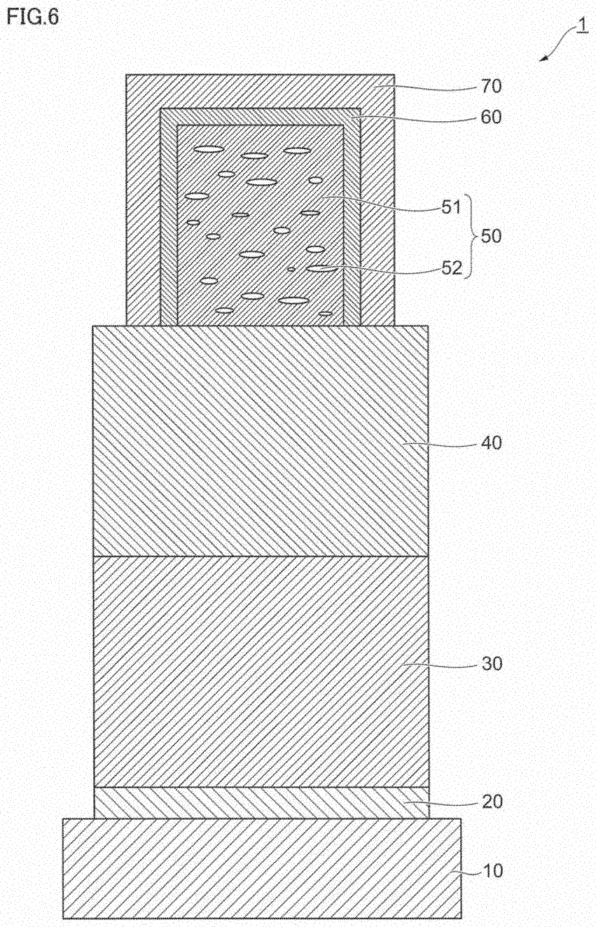

FIG. 6 shows a sectional structure of the lithium-ion rechargeable battery 1 of a first modification of the first embodiment. FIG. 6 shows the lithium-ion rechargeable battery 1 after the initial discharge, namely after completion of its structure (corresponding to FIG. 1 of the first embodiment).

The first modification differs from the first embodiment in that, when viewed from above in FIG. 6, the plane size of the positive electrode collector layer 20 and the positive electrode layer 30 is almost equal to the plane size of the solid electrolyte layer 40. In the first modification too, the storage layer 50 of the lithium-ion rechargeable battery 1 can be made porous (see FIG. 6); this can be done by, in the same procedure as in the first embodiment (see FIG. 2), first manufacturing the lithium-ion rechargeable battery 1 containing the dense storage layer 50 and then subjecting it to the initial charge and discharge following the film deposition.

### Second Modification

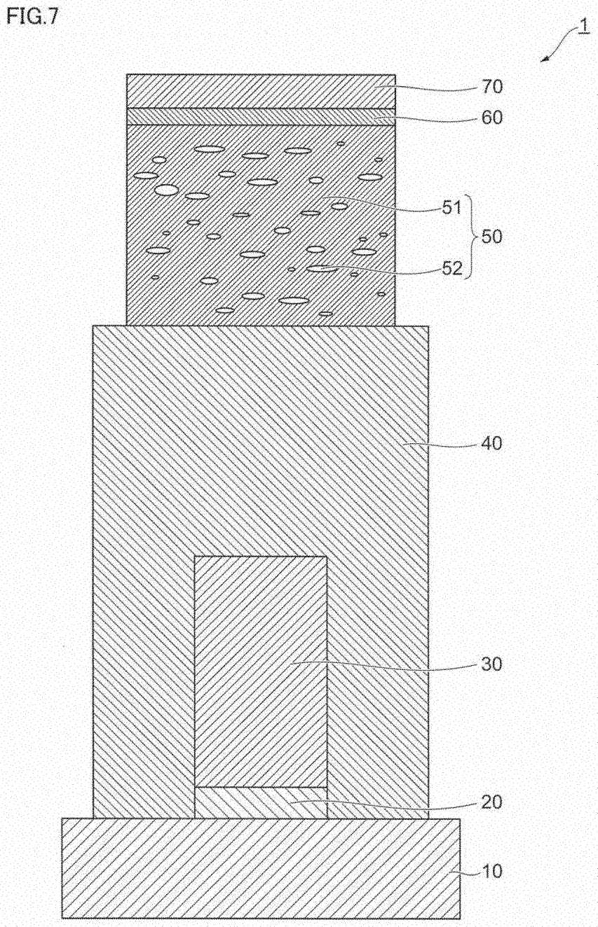

FIG. 7 shows a sectional structure of the lithium-ion rechargeable battery 1 of a second modification of the first embodiment. FIG. 7 shows the lithium-ion rechargeable battery 1 after the initial discharge, namely after completion of its structure (corresponding to FIG. 1 of the first embodiment).

The second modification differs from the first embodiment in that, when viewed from above in FIG. 7, the plane size of the coating layer 60 is equal to the plane size of the storage layer 50, and also the plane size of the negative electrode collector layer 70 is equal to the plane size of the coating layer 60. In the second modification too, the storage layer 50 of the lithium-ion rechargeable battery 1 can be made porous (see FIG. 7); this can be done by, in the same procedure as in the first embodiment (see FIG. 2), first manufacturing the lithium-ion rechargeable battery 1 containing the dense storage layer 50 and then subjecting it to the initial charge and discharge following the film deposition.

### Third Modification

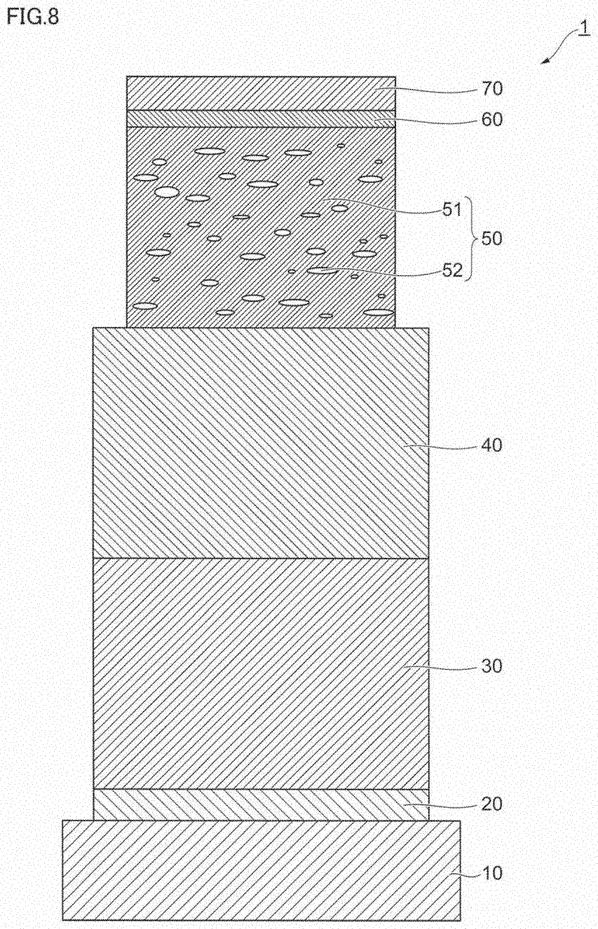

FIG. 8 shows a sectional structure of the lithium-ion rechargeable battery 1 of a third modification of the first embodiment. FIG. 8 shows the lithium-ion rechargeable battery 1 after the initial discharge, namely after completion of its structure (corresponding to FIG. 1 of the first embodiment).

The third modification differs from the first modification in that, when viewed from above in FIG. 8, the plane size of the coating layer 60 is equal to the plane size of the storage layer 50, and also the plane size of the negative electrode collector layer 70 is equal to the plane size of the coating layer 60. In the third modification too, the storage layer 50 of the lithium-ion rechargeable battery 1 can be made porous (see FIG. 8); this can be done by, in the same procedure as in the first embodiment (see FIG. 2), first manufacturing the lithium-ion rechargeable battery 1 containing the dense storage layer 50 and then subjecting it to the initial charge and discharge following the film deposition.

### Fourth Modification

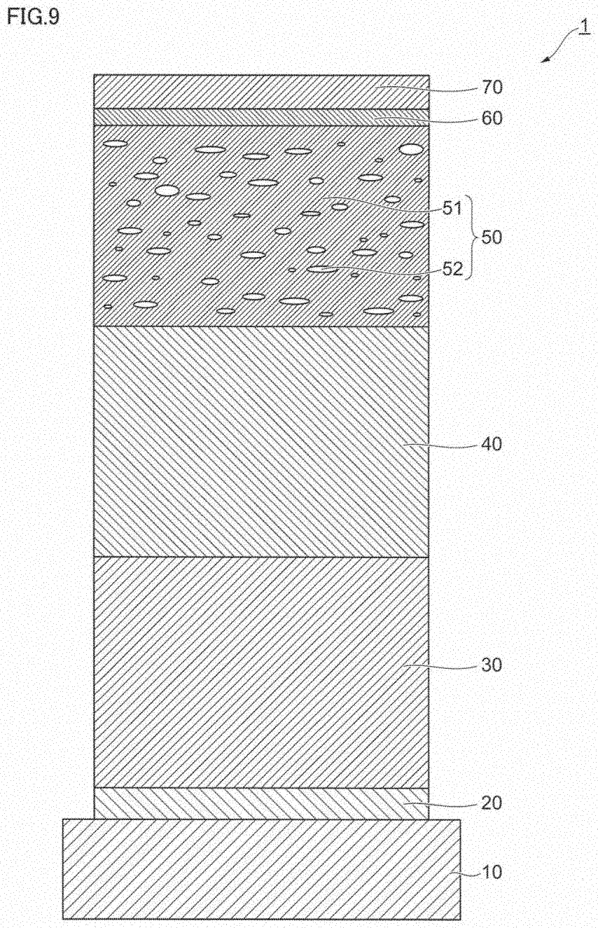

FIG. 9 shows a sectional structure of the lithium-ion rechargeable battery 1 of a fourth modification of the first embodiment. FIG. 9 shows the lithium-ion rechargeable battery 1 after the initial discharge, namely after completion of its structure (corresponding to FIG. 1 of the first embodiment).

The fourth modification differs from the third modification in that, when viewed from above in FIG. 9, the plane size of the storage layer 50 is equal to the plane size of the solid electrolyte layer 40. In the fourth modification too, the storage layer 50 of the lithium-ion rechargeable battery 1 can be made porous (see FIG. 9); this can be done by, in the same procedure as in the first embodiment (see FIG. 2), first manufacturing the lithium-ion rechargeable battery 1 containing the dense storage layer 50 and then subjecting it to the initial charge and discharge following the film deposition.

### Second Embodiment

In the first embodiment, the storage layer 50 is made of a noble metal having a porous structure. In the second embodiment, the storage layer 50 is made of titanium (Ti) including multiple columnar crystals each extending in the thickness direction. In the present embodiment, similar elements to those in the first embodiment are denoted by the same reference numerals, and detailed description thereof will be omitted.

### [Configuration of the Lithium-Ion Rechargeable Battery]

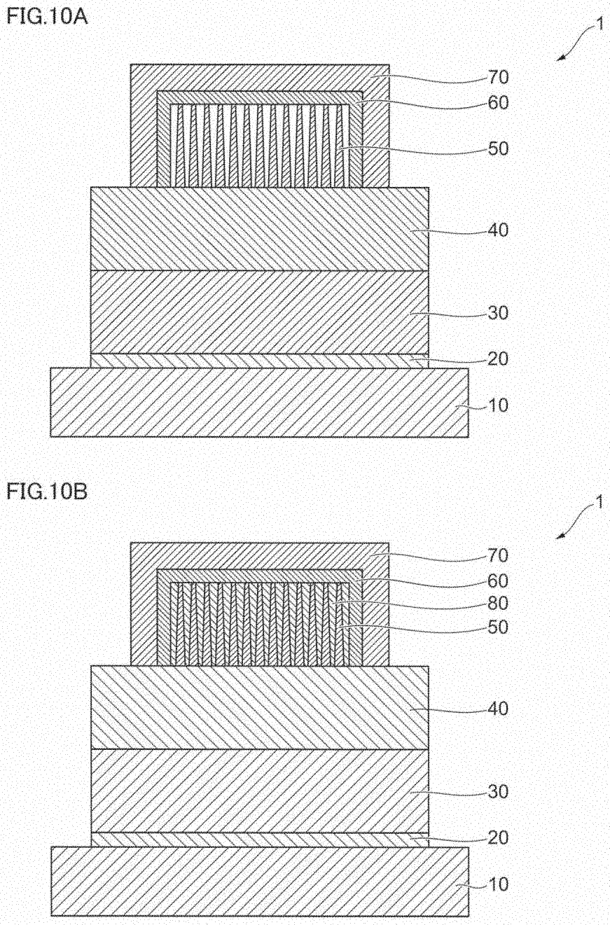

FIGS. 10A and 10B each show a sectional structure of the lithium-ion rechargeable battery 1 of the second embodiment. Similarly to the first embodiment, the lithium-ion rechargeable battery 1 of the present embodiment has a multilayer structure composed of multiple layers (films); its basic structure is formed by a so-called film deposition process, and the structure is completed by a first (initial) charging operation. FIG. 10A shows the lithium-ion rechargeable battery 1 after film deposition and before the initial charge, and FIG. 10B shows the lithium-ion rechargeable battery 1 after the initial charge.

(Configuration of the Lithium-Ion Rechargeable Battery after Film Deposition)

Similarly to the first embodiment, the lithium-ion rechargeable battery 1 after film deposition and before the initial charge includes the substrate 10, the positive electrode collector layer 20, the positive electrode layer 30, the solid electrolyte layer 40, the storage layer 50, the coating layer 60, and the negative electrode collector layer 70 stacked in this order, as shown in FIG. 10A.

(Configuration of the Lithium-Ion Rechargeable Battery after the Initial Charge)

The basic configuration of the lithium-ion rechargeable battery 1 after the initial charge is almost similar to that of the lithium-ion rechargeable battery 1 after the film deposition and before the initial charge shown in FIG. 10A, except that the lithium-ion rechargeable battery 1 after the initial charge includes a negative electrode 80 inside the storage layer 50, as shown in FIG. 10B.

The above constituents of the lithium-ion rechargeable battery 1 will be described in more detail below; the below description focuses on the storage layer 50 and the negative electrode 80 because the other constituents than the storage layer 50 and the negative electrode 80 are similar to those in the first embodiment.

### (Storage Layer)

The storage layer 50 of the present embodiment is a solid thin film and has a structure in which multiple columnar crystals made of metal titanium (Ti) each extending in the thickness direction are arranged side by side. The columnar crystals of titanium constituting the storage layer 50 are typically hexagonal columnar crystals.

The storage layer 50 may have a thickness of 10 nm or more and 40 μm or less, for example. With a thickness of less than 10 nm, the storage layer 50 lacks sufficient capacity to store lithium. Meanwhile, when the storage layer 50 has a thickness of more than 40 μm, it increases internal resistance of the battery, which is disadvantageous for high speed charging/discharging.

While any known deposition method may be used to manufacture the storage layer 50, such as various PVD and CVD methods, it is preferable to use a sputtering method in terms of efficient formation of an aggregate of titanium columnar crystals.

### (Negative Electrode)

The negative electrode 80 contains a negative electrode active material that occludes lithium ions during a charge and releases lithium ions during a discharge. As described above, the negative electrode 80 of the present embodiment is formed inside the storage layer 50 by a charging operation. More specifically, lithium ions are stored at a boundary between each two adjacent columnar crystals, or a so-called crystal grain boundary, in the storage layer 50, whereby the negative electrode 80 is formed. In the present embodiment, metal lithium itself functions as a negative electrode active material.

A preferred method for manufacturing the negative electrode 80 is to form (deposit) the negative electrode 80 by charging.

### [Method for Manufacturing the Lithium-Ion Rechargeable Battery]

Below a description will be given of a method for manufacturing the lithium-ion rechargeable battery 1 shown in FIGS. 10A and 10B. As described above, in the present embodiment, the basic structure of the lithium-ion rechargeable battery 1 shown in FIG. 10A is formed by a so-called film deposition process, and then the lithium-ion rechargeable battery 1 shown in FIG. 10B is obtained by the first (initial) charging operation.

First, the substrate 10 is mounted on a sputtering apparatus (not shown), and the positive electrode collector layer 20, the positive electrode layer 30, the solid electrolyte layer 40, the storage layer 50, the coating layer 60, and the negative electrode collector layer 70 are stacked in this order on the substrate 10. This results in the lithium-ion rechargeable battery 1 after the film deposition and before the initial charge as shown in FIG. 10A. This lithium-ion rechargeable battery 1 is removed from the sputtering apparatus.

Then, the lithium-ion rechargeable battery 1 after the film deposition and before the initial charge as shown in FIG. 10A is given the initial charge. As a result, lithium is deposited on the crystal grain boundaries inside the storage layer 50 of the lithium-ion rechargeable battery 1 shown in FIG. 10A. In other words, the negative electrode 80 made of lithium is formed inside the storage layer 50, resulting in the lithium-ion rechargeable battery 1 after the initial charge as shown in FIG. 10B. The charging and discharging operations of the lithium-ion rechargeable battery 1 will be detailed below.

### [Operation of the Lithium-Ion Rechargeable Battery]

When the lithium-ion rechargeable battery 1 in a discharged state is charged, a positive electrode of a DC power source is connected to the substrate 10, and a negative electrode of the DC power source is connected to the negative electrode collector layer 70. Then, lithium ions constituting the positive electrode active material in the positive electrode layer 30 move through the solid electrolyte layer 40 to the storage layer 50. In other words, in a charging operation, lithium ions move in the thickness direction of the lithium-ion rechargeable battery 1 (in the upward direction in FIGS. 10A and 10B).

At this time, lithium ions having moved from the positive electrode layer 30 toward the storage layer 50 reaches the boundary between the solid electrolyte layer 40 and the storage layer 50. The storage layer 50 includes multiple columnar crystals made of metal titanium and extending in the thickness direction. These columnar crystals are arranged side by side. Thus, lithium ions having reached the boundary between the solid electrolyte layer 40 and the storage layer 50 enter the grain boundary between each two adjacent columnar crystals and move further in the thickness direction to get held within the storage layer 50.

Some of lithium ions having entered the storage layer 50 go therethrough to reach the boundary between the storage layer 50 and the coating layer 60. The coating layer 60 is made of an amorphous metal or alloy having the smaller number of grain boundaries than metal titanium (aggregate of columnar crystals) constituting the storage layer 50. For this reason, lithium ions having reached the boundary between the storage layer 50 and the coating layer 60 are less likely to enter the coating layer 60, and they remain stored within the storage layer 50.

After the charging operation is finished, lithium ions having moved from the positive electrode layer 30 to the storage layer 50 are stored at the grain boundaries between columnar crystals in the storage layer 50, where the lithium ions constitute the negative electrode 80.

When the lithium-ion rechargeable battery 1 in a charged state is discharged (used), a positive side of a load is connected to the substrate 10 and a negative side of the load is connected to the negative electrode collector layer 70. Then, lithium ions contained in the negative electrode 80 inside the storage layer 50 move in the thickness direction (in the downward direction in FIGS. 10A and 10B) through the solid electrolyte layer 40 to the positive electrode layer 30, where the lithium ions constitute the positive electrode active material. Along with this, a direct current is supplied to the load.

After the discharging operation is finished, the negative electrode 80 inside the storage layer 50 does not disappear but remain because of some lithium that does not move during the discharging operation.

### Conclusion of the Second Embodiment

As described above, in the lithium-ion rechargeable battery 1 of the present embodiment, the coating layer 60 made of a metal or an alloy having an amorphous structure is stacked on the storage layer 50 facing the positive electrode layer 30 across the solid electrolyte layer 40. This restrains lithium having moved from the positive electrode layer 30 to the storage layer 50 during the charge operation from leaking outside through the coating layer 60, as compared to, for example, when the coating layer 60 having a polycrystalline structure is stacked on the storage layer 50.

In the present embodiment, the storage layer 50 composed of arranged columnar crystals of titanium is disposed on the solid electrolyte layer 40. This restrains peeling inside the lithium-ion rechargeable battery 1 caused by expansion due to charging or contraction due to discharging, as compared to, for example, when a negative electrode layer made of silicon (Si) is disposed on the solid electrolyte layer 40.

In the present embodiment, the negative electrode collector layer 70 made of platinum is disposed on the coating layer 60. This restrains corrosion (deterioration) of the metal or alloy constituting the coating layer 60 caused by oxidation and the like, as compared to, for example, when the negative electrode collector layer 70 made of a material other than noble metals is disposed on the coating layer 60.

### Third Embodiment

In the first and second embodiments, the storage layer 50 that does not serve as a negative electrode by itself but has the function to store metal lithium serving as a negative electrode is disposed between the solid electrolyte layer 40 and the coating layer 60. In the third embodiment, in contrast to the above embodiments, a layer serving as a negative electrode is disposed between the solid electrolyte layer 40 and the coating layer 60. In the present embodiment, similar elements to those in the first and second embodiments are denoted by the same reference numerals, and detailed description thereof will be omitted.

### [Configuration of the Lithium-Ion Rechargeable Battery]

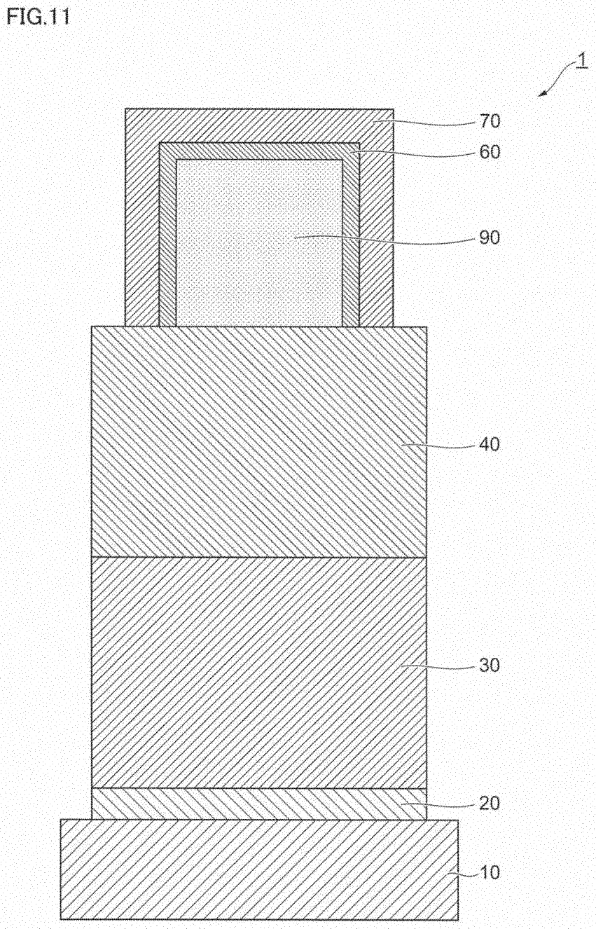

FIG. 11 shows a sectional structure of the lithium-ion rechargeable battery 1 of the third embodiment. Similarly to the first and second embodiments, the lithium-ion rechargeable battery 1 of the present embodiment has a multilayer structure composed of multiple layers (films); unlike the first and second embodiments, however, the structure of the third embodiment is completed by a so-called film deposition process.

The lithium-ion rechargeable battery 1 of the present embodiment includes the substrate 10, the positive electrode collector layer 20, the positive electrode layer 30, the solid electrolyte layer 40, a negative electrode layer 90, the coating layer 60, and the negative electrode collector layer 70 stacked in this order. That is, the lithium-ion rechargeable battery 1 of the present embodiment includes the negative electrode layer 90 at the position corresponding to the storage layer 50 in the first and second embodiments.

The above constituents of the lithium-ion rechargeable battery 1 will be described in more detail below; the below description focuses on the negative electrode layer 90 because the other constituents than the negative electrode layer 90 are similar to those in the first and second embodiments.

### (Negative Electrode Layer)

The negative electrode layer 90 (an example of the storage layer) is a solid thin film and contains a negative electrode active material that occludes lithium ions during a charge and releases lithium ions during a discharge. The negative electrode layer 90 of the present embodiment is made of doped amorphous silicon (Si). In the present embodiment, silicon serves as a negative electrode active material occluding and releasing lithium ions. The negative electrode layer 90 may, however, be made of a material other than silicon, and also the dopant is not essential.

The dopant for silicon constituting the negative electrode layer 90 is not limited to a particular one as long as the dopant increases conductivity of silicon; the dopant may be one or more of various elements. Among the elements, use is preferably made of zinc (Zn), cadmium (Cd), boron (B), aluminum (Al), gallium (Ga), indium (In), and thallium (Tl), which serve as an acceptor to form a p-type negative electrode layer 90, or use is preferably made of nitrogen (N), phosphorus (P), arsenic (As), sulfur (S), selenium (Se) and tellurium (Te), which serve as a donor to form an n-type negative electrode layer 90. Among these, boron (B) is preferable in particular.

The negative electrode layer 90 may have a thickness of 10 nm or more and 20 μm or less, for example. With the negative electrode layer 90 having a thickness of less than 10 nm, the lithium-ion rechargeable battery 1 obtained therefrom has a too small capacity, which makes the lithium-ion rechargeable battery 1 impracticable. Meanwhile, when the negative electrode layer 90 has a thickness of more than 20 μm, it increases internal resistance of the battery, which is disadvantageous for high speed charging/discharging. The negative electrode layer 90 may, however, have a thickness of more than 20 μm when a large battery capacity is required of the lithium-ion rechargeable battery 1.

While any known deposition method may be used to manufacture the negative electrode layer 90, such as various PVD and CVD methods, it is preferable to use a sputtering method in terms of production efficiency.

### [Method for Manufacturing the Lithium-Ion Rechargeable Battery]

Below a description will be given of a method for manufacturing the lithium-ion rechargeable battery 1 shown in FIG. 11.

First, the substrate 10 is mounted on a sputtering apparatus (not shown), and the positive electrode collector layer 20, the positive electrode layer 30, the solid electrolyte layer 40, the negative electrode layer 90, the coating layer 60, and the negative electrode collector layer 70 are stacked in this order on the substrate 10. This results in the lithium-ion rechargeable battery 1 as shown in FIG. 11. This lithium-ion rechargeable battery 1 is removed from the sputtering apparatus.

### [Operation of the Lithium-Ion Rechargeable Battery]

When the lithium-ion rechargeable battery 1 in a discharged state is charged, a positive electrode of a DC power source is connected to the substrate 10, and a negative electrode of the DC power source is connected to the negative electrode collector layer 70. Then, lithium ions constituting the positive electrode active material in the positive electrode layer 30 move through the solid electrolyte layer 40 to the negative electrode layer 90. In other words, in a charging operation, lithium ions move in the thickness direction of the lithium-ion rechargeable battery 1 (in the upward direction in FIG. 11).

At this time, lithium ions having moved from the positive electrode layer 30 toward the negative electrode layer 90 reaches the boundary between the solid electrolyte layer 40 and the negative electrode layer 90. The negative electrode layer 90 is made of silicon doped with boron as a dopant. Thus, lithium ions having reached the boundary between the solid electrolyte layer 40 and the negative electrode layer 90 get held in the negative electrode layer 90.

Some of lithium ions having entered the negative electrode layer 90 go therethrough to reach the boundary between the negative electrode layer 90 and the coating layer 60. The coating layer 60 is made of a metal or an alloy that is amorphized and thus has the reduced number of grain boundaries. For this reason, lithium ions having reached the boundary between the negative electrode layer 90 and the coating layer 60 are less likely to enter the coating layer 60, and they remain stored within the negative electrode layer 90.

When the lithium-ion rechargeable battery 1 in a charged state is discharged (used), a positive side of a load is connected to the substrate 10 and a negative side of the load is connected to the negative electrode collector layer 70. Then, lithium ions present in the negative electrode layer 90 move in the thickness direction (in the downward direction in FIG. 11) through the solid electrolyte layer 40 to the positive electrode layer 30, where the lithium ions constitute the positive electrode active material. Along with this, a direct current is supplied to the load.

### Conclusion of the Third Embodiment

As described above, in the lithium-ion rechargeable battery 1 of the present embodiment, the coating layer 60 made of a metal or an alloy having an amorphous structure is stacked on the negative electrode layer 90 facing the positive electrode layer 30 across the solid electrolyte layer 40. This restrains lithium having moved from the positive electrode layer 30 to the negative electrode layer 90 during the charging operation from leaking outside through the coating layer 60, as compared to, for example, when the coating layer 60 having a polycrystalline structure is stacked on the negative electrode layer 90.

In the present embodiment, the negative electrode layer 90 is made of silicon containing boron. This increases the capacity of the lithium-ion rechargeable battery 1 at a given thickness (volume), as compared to, for example, when the negative electrode layer 90 is made of carbon (C).

In the present embodiment, the negative electrode collector layer 70 made of platinum is disposed on the coating layer 60. This restrains corrosion (deterioration) of the metal or alloy constituting the coating layer 60 caused by oxidation and the like, as compared to, for example, when the negative electrode collector layer 70 made of a material other than noble metals is disposed on the coating layer 60.

### Other Notes

In the first to third embodiments, the coating layer 60 is disposed on the storage layer 50 (or the negative electrode layer 90). The present invention is, however, not limited to this configuration; a layer (an amorphous metal or alloy layer for preventing diffusion of lithium) similar to the coating layer 60 may be disposed on the positive electrode layer 30 side. In this case, the positive electrode layer 30 serves as an example of the storage layer. In one implementation, an amorphous metal or alloy layer may be disposed between the positive electrode collector layer 20 and the positive electrode layer 30. In another implementation, the positive electrode collector layer 20 itself may be composed of an amorphous metal or alloy layer.

Still alternatively, a layer corresponding to the coating layer 60 may be disposed on both of the positive electrode layer 30 side and the storage layer 50 (or the negative electrode layer 90) side.

### REFERENCE SIGNS LIST

1 Lithium-ion rechargeable battery
10 Substrate
20 Positive electrode collector layer
30 Positive electrode layer
40 Solid electrolyte layer
50 Storage layer
51 Porous part
52 Pore
60 Coating layer
70 Negative electrode collector layer
80 Negative electrode
90 Negative electrode layer

1. A lithium-ion rechargeable battery comprising, in the following order:
a solid electrolyte layer containing an inorganic solid electrolyte having lithium ion conductivity;
a storage layer configured to store lithium; and
an amorphous metal layer made of a metal or an alloy and having an amorphous structure.

2. The lithium-ion rechargeable battery according to claim 1, wherein the amorphous metal layer contains chromium (Cr).

3. The lithium-ion rechargeable battery according to claim 2, wherein the amorphous metal layer is made of an alloy of chromium (Cr) and titanium (Ti).

4. The lithium-ion rechargeable battery according to claim 1, wherein the amorphous metal layer is made of a metal or an alloy that does not form an intermetallic compound with lithium.

5. The lithium-ion rechargeable battery according to claim 1, wherein the amorphous metal layer is made of any one of ZrCuAlNiPdP, CuZr, FeZr, TiZr, CoZrNb, NiNb, NiTiNb, NiP, CuP, NiPCu, NiTi, CrTi, AlTi, FeSiB, and AuSi.

6. The lithium-ion rechargeable battery according to claim 1, wherein the storage layer is made of a platinum group element (Ru, Rh, Pd, Os, Ir, or Pt) having a porous structure, gold (Au) having a porous structure, or an alloy of some of the platinum group elements or at least one of the platinum group elements and the gold having a porous structure.

7. The lithium-ion rechargeable battery according to claim 1, wherein the storage layer is made of titanium having a plurality of columnar crystals each extending in a thickness direction.

8. The lithium-ion rechargeable battery according to claim 1, wherein the storage layer contains a negative electrode active material.

9. The lithium-ion rechargeable battery according to claim 1, wherein the storage layer contains a positive electrode active material.

10. The lithium-ion rechargeable battery according to claim 1, further comprising a positive electrode layer on an opposite side of the solid electrolyte layer from the storage layer, the positive electrode layer containing a positive electrode active material, wherein
a plane size of the storage layer is larger than a plane size of the positive electrode layer.

11. The lithium-ion rechargeable battery according to claim 1, further comprising a noble metal layer on the amorphous metal layer, the noble metal layer being made of a platinum group element (Ru, Rh, Pd, Os, Ir, or Pt), gold (Au), or an alloy of some of the platinum group elements or at least one of the platinum group elements and the gold.
